(19) United States
(12) Patent Application Publication
(10) Pub. No.: US 2008/0042946 A1
(43) Pub. Date: Feb. 21, 2008

(54) DISPLAY PANEL, DISPLAY APPARATUS HAVING THE SAME AND A METHOD OF DRIVING THE DISPLAY APPARATUS

(75) Inventors: Kyong-Tae Park, Euijeongbu-si (KR); Beohm-Rock Choi, Seoul (KR); Young-Soo Yun, Suwon-si (KR); Sung-Soo Lee, Suwon-si (KR); Young-Rok Song, Yongin-si (KR); Ji-Hye Choi, Yongin-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD., Suwon-si (KR)

(21) Appl. No.: 11/841,106

(22) Filed: Aug. 20, 2007

(30) Foreign Application Priority Data
Aug. 18, 2006 (KR) 10-2006-0078089

(51) Int. Cl. G09G 3/32

(52) U.S. Cl. 345/82

(57) ABSTRACT

A display panel includes a plurality of data lines each extended in a first direction substantially parallel with each other, a plurality of driving voltage lines each extended substantially parallel with the plurality of data lines, a plurality of gate lines each extended in a second direction substantially perpendicular to the first direction and a plurality of unit pixels each including a plurality of sub-pixels, each sub-pixel of a corresponding unit pixel having two short sides defined by two adjacent data lines and two long sides defined by two adjacent gate lines. Each sub-pixel of the corresponding unit pixel includes a switching element electrically connected to a same data line of the two adjacent data lines and one of the two adjacent gate lines, and a driving element electrically connected to the switching element and a same driving voltage line, the driving element drives a light-emitting element.

This application claims priority to Korean Patent Application No. 2006-78089, filed on Aug. 18, 2006, and all the benefits accruing therefrom under 35 U.S.C. §119, the contents of which in its entirety are herein incorporated by reference.

### BACKGROUND OF THE INVENTION

1. Field of the Invention

The present invention relates to a display panel, a display apparatus having the display panel and a method of driving the display apparatus. More particularly, the present invention relates to a display panel capable of improving an aperture ratio, a display apparatus having the display panel and a method of driving the display apparatus.

2. Description of the Related Art

A conventional organic light-emitting display panel includes a pixel emitting light through an organic light-emitting element. The pixel includes an organic light-emitting element, a switching thin film transistor (“TFT”), a driving TFT and a storage capacitor. Gate and source electrodes of the switching TFT are respectively connected to gate and source lines. A first electrode of the storage capacitor is electrically connected to the switching TFT, and a second electrode of the storage capacitor is electrically connected to a bias voltage line to which an external bias voltage Vdd is applied. A gate electrode of the driving TFT is electrically connected to a drain electrode of the switching TFT. A source electrode of the driving TFT is electrically connected to the bias voltage line. The driving TFT drives the organic light-emitting element.

As described above, the pixel includes a gate line, a data line and a bias voltage line to drive the organic light-emitting element. The data line and the bias voltage line extend substantially parallel with each other and are separated from each other to prevent an electrical short between the data line and the bias voltage line, which may happen during manufacturing processes.

When a unit pixel includes four sub-pixels having a first sub-pixel of red R, a second sub-pixel of green G, a third sub-pixel of blue B and a fourth sub-pixel of white W, the total number of the data lines and the bias voltage lines increase since each sub-pixel requires a corresponding data line and a corresponding bias voltage line. Therefore, an aperture ratio of the unit pixel is decreased.

### BRIEF SUMMARY OF THE INVENTION

The present invention provides a display panel that may increase an aperture ratio.

The present invention further provides a display apparatus having the display panel.

A display panel according to an exemplary embodiment of the present invention includes a plurality of data lines each extended in a first direction substantially parallel with each other, a plurality of driving voltage lines each extended substantially parallel with the plurality of data lines, a plurality of gate lines each extended in a second direction substantially perpendicular to the first direction and a plurality of unit pixels each including a plurality of a sub-pixels, each sub-pixel of a corresponding unit pixel including a switching element electrically connected to a same data line of two adjacent data lines and one of two adjacent gate lines, and a driving element electrically connected to the switching element and a same driving voltage line, the driving element drives a light-emitting element.

A display apparatus according to another exemplary embodiment of the present invention includes a display panel including a plurality of unit pixels, each unit pixel including a first sub-pixel which includes a first light-emitting element electrically connected to a data line and a first gate line, the first light-emitting element emits light having a first color, a second sub-pixel which includes a second light-emitting element electrically connected to the data line and a second gate line, the second light-emitting element emits light having a second color, a third sub-pixel which includes a third light-emitting element electrically connected to the data line and a third gate line, the third light-emitting element emits light having a third color and a fourth sub-pixel which includes a fourth light-emitting element electrically connected to the data line and a fourth gate line, the fourth light-emitting element emits light having a fourth color. The display panel further includes a source driver which sequentially outputs a first data signal of the first color, a second data signal of the second color, a third data signal of the third color and a fourth data signal of the fourth color to the data line during a one horizontal (“1H”) period and a gate driver which sequentially outputs first to fourth gate signals to the first to fourth gate lines.

A method of driving a display apparatus according to another exemplary embodiment of the present invention includes receiving a driving control signal to drive a display apparatus, the display apparatus includes a data line, a driving voltage line, a gate line which includes first to third gate lines and a unit pixel part which includes a first sub-pixel electrically connected to the data line and the first gate line, a second sub-pixel electrically connected to the data line and the second gate line and a third sub-pixel electrically connected to the data line and the third gate line, each sub-pixel includes a switching element and a driving element, the switching element and the driving element electrically connected to the data line and the driving voltage line, converting the driving control signal from a digital typed signal to an analog typed signal and outputting the analog typed signal to the data line electrically connected to the first to third sub-pixels, in which the driving elements of each sub-pixel corresponding to a unit pixel part are supplied with voltage from the driving voltage line.

According to the display panel, the display apparatus having the display panel and a method of driving the display apparatus, an aperture ratio may be improved and manufacturing costs may be reduced.

### BRIEF DESCRIPTION OF THE DRAWINGS

The above and other aspects, features and advantages of the present invention will become more apparent by describing in more detail exemplary embodiments thereof with reference to the accompanying drawings, in which:

FIG. 1 is an equivalent circuit diagram illustrating a display panel according to an exemplary embodiment of the present invention;

FIG. 2 is a plan view illustrating the exemplary display panel shown in FIG. 1;

FIG. 3 is a cross-sectional view of the exemplary display panel taken along line I-I′ in FIG. 2;

FIG. 4 is a cross-sectional view illustrating a display panel according to another exemplary embodiment of the present invention;

FIG. 5 is a block diagram illustrating a display apparatus according to another exemplary embodiment of the present invention;

FIG. 6 is a block diagram illustrating a source driving part shown in FIG. 5; and

FIG. 7 is a timing diagram illustrating an exemplary method of driving the display apparatus shown in FIG. 5.

### DETAILED DESCRIPTION OF THE INVENTION

The present invention will now be described more fully hereinafter with reference to the accompanying drawings, in which exemplary embodiments of the present invention are shown. This invention may, however, be embodied in many different forms and should not be construed as limited to the exemplary embodiments set forth herein. Rather, these exemplary embodiments are provided so that this disclosure will be thorough and complete, and will fully convey the scope of the present invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Exemplary embodiments of the present invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will now be described more fully with reference to the accompanying drawings.

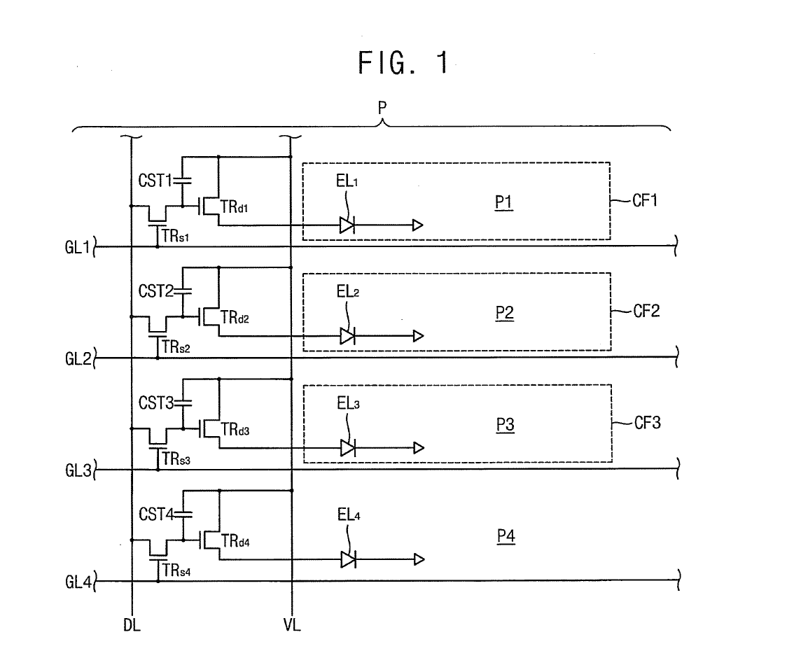

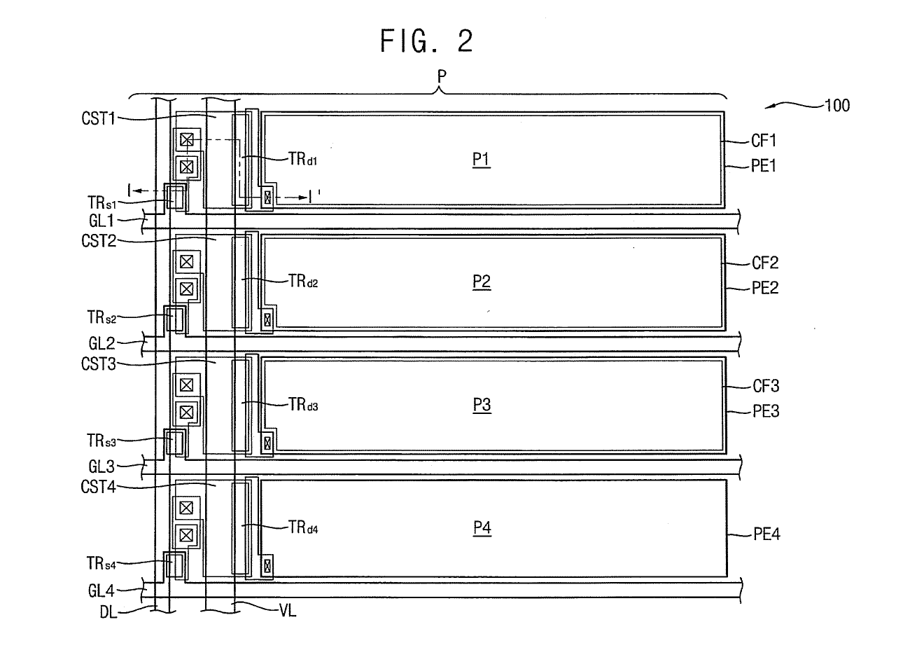

FIG. 1 is an equivalent circuit diagram illustrating a display panel according to an exemplary embodiment of the present invention. FIG. 2 is a plan view illustrating the exemplary display panel shown in FIG. 1.

Referring to FIGS. 1 and 2, an exemplary embodiment of the display panel includes a data line DL, a driving voltage line VL, a gate line GL and a plurality of unit pixels P. Each of the unit pixels P includes first to fourth sub-pixels P1, P2, P3 and P4, respectively emitting first to fourth colors.

The data line DL extends in a first direction. The driving voltage line VL extends substantially parallel with the data line DL and adjacent to the data line DL. The gate line GL extends in a second direction substantially perpendicular to the first direction.

The first to fourth sub-pixels P1, P2, P3 and P4 of a corresponding unit pixel P includes two short sides defined by two adjacent data lines and two long sides defined by two adjacent gate lines. The first to fourth sub-pixels P1, P2, P3 and P4 include a switching element TRs1 electrically connected to a same data line DL of the two adjacent data lines and one of the two gate lines GL, and a driving element TRd1 electrically connected to the switching element TRs1 and a same driving voltage line VL. The driving element TRd1 drives a light-emitting element EL1. The first to fourth sub-pixels P1, P2, P3 and P4 further include a storage capacitor CST1. The storage capacitor CST1 includes a first electrode electrically connected to the switching element TRs1 and the driving element TRd1, and a second electrode electrically connected to same driving voltage line VL.

The first sub-pixel P1 includes a first switching element TRs1, a first storage capacitor CST1, a first driving element TRd1 and a first light-emitting element EL1. The first sub-pixel P1 emits light of a first color. The first sub-pixel P1 includes a filter layer CF1 of the first color to emit light of the first color. In one exemplary embodiment, the first sub-pixel P1 includes a first light-emitting layer emitting light of the first color. Thus, the first sub-pixel P1 emits light of the first color. In another exemplary embodiment, the first color is red.

A gate electrode of the first switching element TRs1 is electrically connected to a (4j-3)-th gate line GL1, and a source electrode of the first switching element TRs1 is electrically connected to an i-th data line DL, wherein ‘i’ and ‘j’ are natural numbers. A drain electrode of the first switching element TRs1 is electrically connected to the first storage capacitor CST1 and the first driving element TRd1.

A first electrode of the first storage capacitor CST1 is electrically connected to the first switching element TRs1. A second electrode of the first storage capacitor CST1 is electrically connected to an i-th driving voltage line VL. A gate electrode of the first driving element TRd1 is electrically connected to the first switching element TRs1. A source electrode of the first driving element TRd1 is electrically connected to the i-th driving voltage line VL. A drain electrode of the first driving element TRd1 is electrically connected to a first light-emitting element EL1. A first electrode (anode) of the first light-emitting element EL1 is electrically connected to the first driving element TRd1. A common voltage is applied to a second electrode (cathode) of the first light-emitting element EL1.

The second sub-pixel P2 includes a second switching element TRs2, a second storage capacitor CST2, a second driving element TRd2 and a second light-emitting element EL2. The second sub-pixel P2 emits light of a second color. The second sub-pixel P2 includes a filter layer CF2 of the second color to emit light of the second color. In one exemplary embodiment, the second sub-pixel P2 includes a second light-emitting layer emitting light of the second color. Thus, the second sub-pixel P2 emits light of the second color. In another exemplary embodiment, the second color is green.

A gate electrode of the second switching element TRs2 is electrically connected to a (4j-2)-th gate line GL2. A source electrode of the second switching element TRs2 is electrically connected to an i-th data line DL. A drain electrode of the second switching element TRs2 is electrically connected to the second storage capacitor CST2 and the second driving element TRd2.

A first electrode of the second storage capacitor CST2 is electrically connected to the second switching element TRs2, and a second electrode of the second storage capacitor CST2 is electrically connected to the i-th driving voltage line VL. A gate electrode of the second driving element TRd2 is electrically connected to the second switching element TRs2. A source electrode of the second driving element TRd2 is electrically connected to the i-th driving voltage line VL. A drain electrode of the second driving element TRd2 is electrically connected to the second light-emitting element EL2. A first electrode (anode) of the second light-emitting element EL2 is electrically connected to the second driving element TRd2. The common voltage is applied to a second electrode (cathode) of the second light-emitting element EL2.

The third sub-pixel P3 includes a third switching element TRs3, a third storage capacitor CST3, a third driving element TRd3 and a third light-emitting element EL3. The third sub-pixel P3 emits light of a third color. The third sub-pixel P3 includes a filter layer CF3 of the third color. In one exemplary embodiment, the third sub-pixel P3 includes a light-emitting layer emitting light of the third color. Thus, the third sub-pixel P3 emits light of the third color. In another exemplary embodiment, the third color is blue.

A gate electrode of the third switching element TRs3 is electrically connected to a (4j-1)-th gate line GL3. A source electrode of the third switching element TRs3 is electrically connected to the i-th data line DL. A drain electrode of the third switching element TRs3 is electrically connected to the third storage capacitor and the third driving element TRd3.

A first electrode of the third storage capacitor CST3 is electrically connected to the third switching element TRs3, and a second electrode of the third storage capacitor CST3 is electrically connected to the i-th driving voltage line VL. A gate electrode of the third driving element TRd3 is electrically connected to the third switching element TRs3. A source electrode of the third driving element TRd3 is electrically connected to the i-th driving voltage line VL. A drain electrode of the third driving element TRd3 is electrically connected to the third light-emitting element EL3. A first electrode (anode) of the third light-emitting element EL3 is electrically connected to the third driving element TRd3. The common voltage is applied to a second electrode (cathode) of the third light-emitting element EL3.

The fourth sub-pixel P4 includes a fourth switching element TRs4, a fourth storage capacitor CST4, a fourth driving element TRd4 and a fourth light-emitting element EL4. The fourth sub-pixel P4 emits light of a fourth color. In one exemplary embodiment, the fourth sub-pixel P4 may lack a color filter layer. In another exemplary embodiment, the fourth sub-pixel P4 may include a light-emitting layer generating a white color. In a further exemplary embodiment, the fourth color is white.

A gate electrode of the fourth switching element TRs4 is electrically connected to a 4j-th gate line GL4. A source electrode of the fourth switching element TRs4 is electrically connected to the i-th data line DL. A drain electrode of the fourth switching element TRs4 is electrically connected to the fourth storage capacitor CST4 and the fourth driving element TRd4. A first electrode of the fourth storage capacitor CST4 is electrically connected to the fourth switching element TRs4, and a second electrode of the fourth storage capacitor CST4 is electrically connected to the i-th driving voltage line VL. A gate electrode of the fourth driving element TRd4 is electrically connected to the fourth switching element TRs4, A source electrode of the fourth driving element TRd4 is electrically connected to the i-th driving voltage line VL. A drain electrode of the fourth driving element TRd4 is electrically connected to the fourth light-emitting element EL4. A first electrode (anode) of the fourth light-emitting element EL4 is electrically connected to the fourth driving element TRd4. The common voltage is applied to a second electrode (cathode) of the fourth light-emitting element EL4.

As described above, the first to fourth sub-pixels P1, P2, P3 and P4 each use the i-th data line DL and the i-th driving voltage line VL. The amount of data lines and bias voltage lines corresponding to the sub-pixels are thereby reduced. Therefore, an aperture ratio is improved.

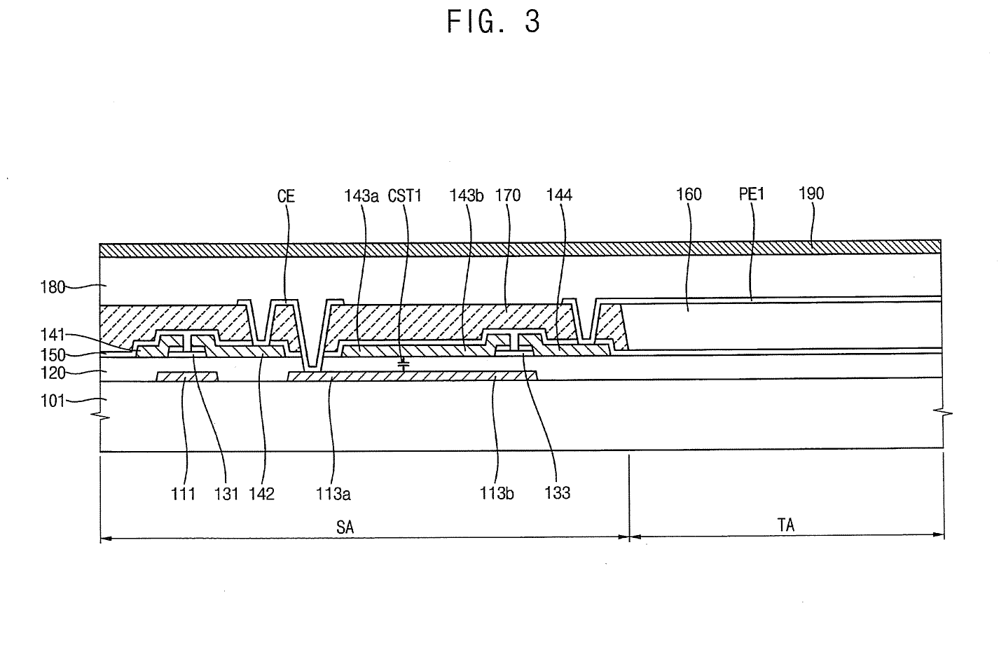

FIG. 3 is a cross-sectional view of the exemplary display panel taken along line I-I′ in FIG. 2.

Referring to FIGS. 2 and 3, the exemplary display panel includes a transparent material. The display panel includes a base substrate 101 having first and second surfaces.

A gate pattern including a gate metal layer is formed on the first surface of the base substrate 101. The gate pattern includes the (4j-3)-th gate line GL1, the gate electrode 111 of the first switching element TRs1 electrically connected to the (4j-3)-th gate line GL1, the first electrode 113a of the first storage capacitor CST1 and the gate electrode of the first driving element TRd1. A pattern 113 includes the first electrode 113a of the first storage capacitor CST1 and the gate electrode 113b of the driving element TRd1.

The gate insulating layer 120 is formed on the base substrate 101 having the gate pattern formed on the base substrate 101. The gate insulating layer 120 electrically insulates the gate pattern from conducting patterns which is to be formed on the gate insulating layer 120.

First channel layer 131 corresponding to the gate electrode of the first switching element TRs1 and second channel layer 133 corresponding to the gate electrode of the first driving element TRd1 are formed on the gate insulating layer 120.

A source pattern including a source metal layer is formed on the base substrate 101 having the first channel layer 131 and the second channel layer 133 formed on the base substrate 101. The source pattern includes the i-th data line DL, the i-th driving voltage line VL, the source and drain electrodes 141 and 142, respectively, of the first switching element TRs1, the source and drain electrodes 143b and 144, respectively, of the first driving element TRd1 and the second electrode 143a of the first storage capacitor CST1. The i-th data line DL and the source electrode 141 of the first switching element TRs1 are integrally formed. The second electrode 143a of the first storage capacitor CST1 and the source electrode 143b of the first driving element TRd1 are integrally formed.

A passivation layer 150 is formed on the base substrate 101 having the source pattern formed on the base substrate 101. A color filter layer 160 and a light shielding layer 170 are formed on the passivation layer 150.

In one exemplary embodiment, the color filter layer 160 may be formed at a light transmitting area TA of an area corresponding to the first sub-pixel P1. The gate and source patterns are not formed under the light transmitting area TA. In another exemplary embodiment, the light shielding layer 170 may be formed at a light shielding area SA of the area corresponding to the first sub-pixel P1. The gate and source patterns are formed under the light shielding area SA.

A first pixel electrode PE1 and a contact electrode CE, each of which include a transparent conductive material, are formed on the color filter layer 160 and on the light shielding layer 170. The first pixel electrode PE1 is electrically connected to the drain electrode 144 of the first driving element TRd1 through a contact hole. The first pixel electrode PE1 is an anode of the first light-emitting element EL1.

The contact electrode CE electrically connects the drain electrode 142 of the first switching element TRs1 with the first electrode 113a of the first storage capacitor CST1 through the contact hole.

A light-emitting layer 180 is formed on the base substrate 101 having the first pixel electrode PE1 and the contact electrode CE formed on the base substrate 101. The light-emitting layer 180 emits white light.

In the current embodiment, the light-emitting layer 180 includes a hole injecting layer, a hole conveying layer, an organic luminescence layer and an electron conveying layer which are sequentially stacked. In an alternative exemplary embodiment, the light-emitting layer 180 may include a hole conveying layer, an organic luminescence layer and an electron conveying layer which are sequentially stacked. In a further exemplary embodiment, the light-emitting layer 180 may include a hole injecting layer, a hole conveying layer, an organic luminescence layer, an electron conveying layer and an electron injecting layer which are sequentially stacked.

A metal electrode layer 190 is formed on the light-emitting layer 180. The metal electrode layer 190 is a cathode of the first light-emitting element EL1. The metal electrode layer 190 receives the common voltage.

The first light-emitting element EL1 emits light through a bottom luminescence method. Namely, when voltage is applied to the first pixel electrode PE1 and the metal electrode layer 190, the light-emitting layer 180 emits light. The light emitted by the light-emitting layer 180 is reflected by the metal electrode layer 190 and the emitted light enters into the color filter layer 160. Colored light passing through the color filter layer 160 is emitted from a second surface of the base substrate 101.

As described above, the aperture ratio of each of the first to fourth sub-pixels P1, P2, P3 and P4 may be increased as signals are applied to the first to fourth sub-pixels P1, P2, P3 and P4 through the i-th data line DL and the i-th driving voltage line VL. Therefore, the aperture ratio of the unit pixel P may be improved.

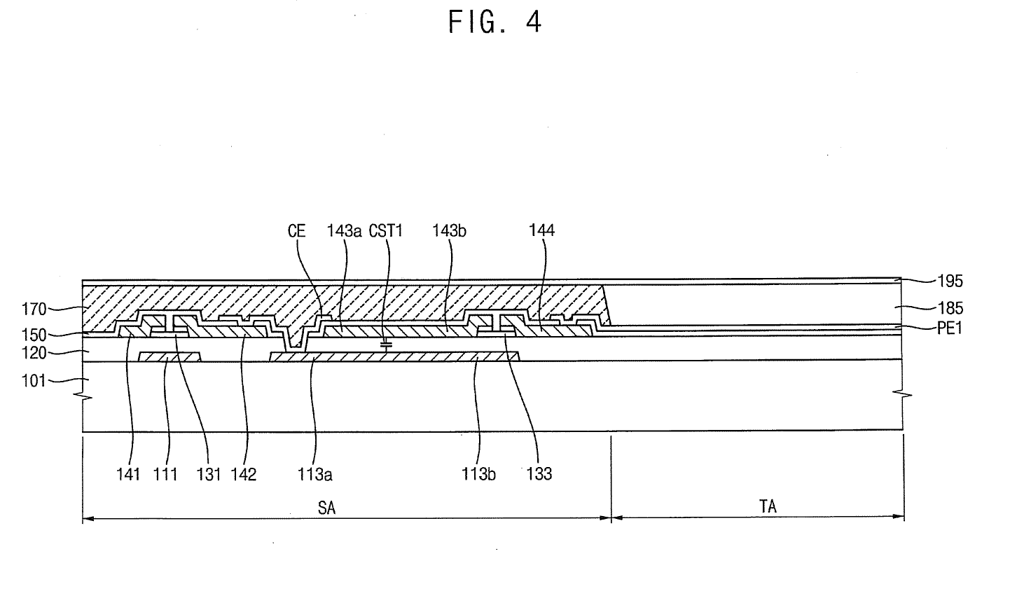

FIG. 4 is a cross-sectional view illustrating a display panel according to another exemplary embodiment of the present invention. The display panel shown in FIG. 4 employs an independent luminescence driving method and a top luminescence driving method. The same reference numerals will be used to refer to the same or like parts as those described in the display panel in FIG. 3 and further explanation concerning the above elements will now be described.

Referring to FIG. 4, in an exemplary embodiment, the gate pattern GL1, 111, 113a and 113b, the gate insulating layer 120, the first channel layer 131 and the second channel layer 133, the source pattern DL, VL, 141, 142, 143a, 143b and 144, and the passivation layer 150 are sequentially formed on the base substrate 101 to form the first switching element TRs1, the first driving element TRd1 and the first storage capacitor CST1.

The passivation layer 150 includes a contact hole. The first pixel electrode PE1 and the contact electrode CE, including a transparent conductive material, are formed on the passivation layer 150.

The first pixel electrode PE1 is electrically connected to the drain electrode 144 of the first driving element TRd1 through the contact hole. The first pixel electrode PE1 is an anode of the first light-emitting element EL1. The contact electrode CE electrically connects the drain electrode 142 of the first switching element TRs1 with the first electrode 113a of the first storage capacitor CST1 through the contact hole.

The light shielding layer 170 is formed on the light shielding area SA of the base substrate 101 having the first pixel electrode PE1 formed on the base substrate 101. The light-emitting layer 185 is formed on the light transmitting area TA of the base substrate 101 having the first pixel electrode PE1 formed on the base substrate 101.

The light-emitting layer 185 includes an organic luminescence layer emitting a specific colored light, the specific color corresponds to the location of the organic luminescence layer. In one exemplary embodiment, the light-emitting layer 185 corresponding to the first sub-pixel P1 emits red light. The light-emitting layer emitting green light is formed in the second sub-pixel P2. The light-emitting layer emitting blue light is formed in the third sub-pixel P3. The light-emitting layer emitting white light is formed in the fourth sub-pixel P4.

An opposite electrode layer 195 including a transparent conductive material is formed on the base substrate 101 having the light shielding layer 170 and the light-emitting layer 185 formed on the base substrate 101. The opposite electrode layer 195 is a cathode of the first light-emitting element EL1. The opposite electrode layer 195 receives the common voltage.

The first light-emitting element EL1 emits light through the top luminescence method. When a voltage is applied to the first pixel electrode PE1 and the opposite electrode layer 195, the light-emitting layer 185 emits light. Colored light emitted from the light-emitting layer 185 passes through the opposite electrode layer 195 and is emitted from the first surface of the base substrate 101.

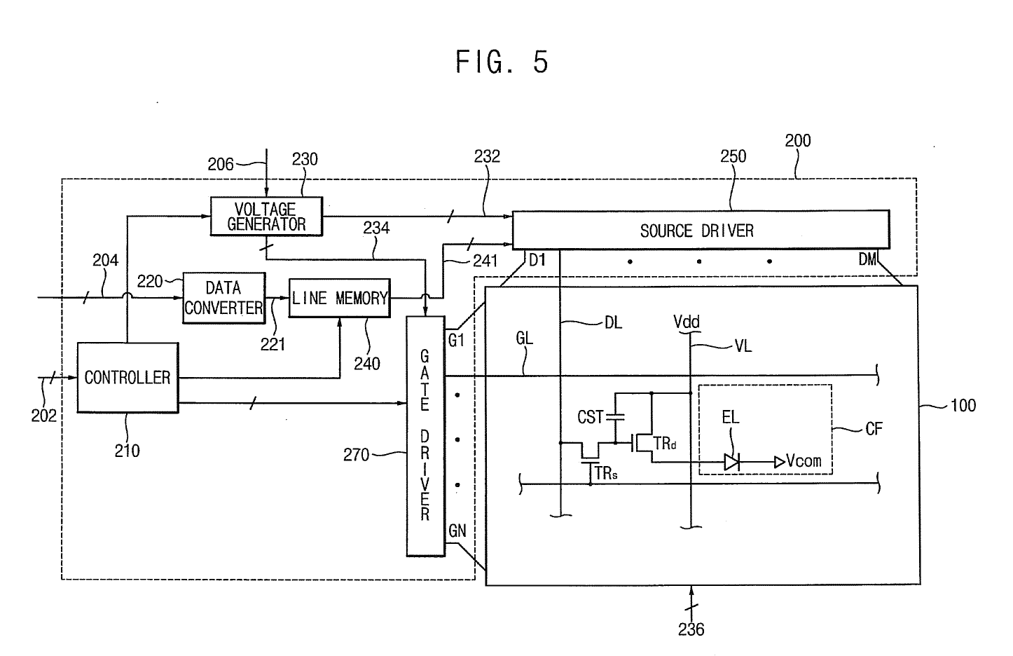

FIG. 5 is a block diagram illustrating an organic light-emitting display apparatus according to another exemplary embodiment of the present invention.

Referring to FIG. 5, in an exemplary embodiment, the organic light-emitting display apparatus includes a light-emitting display panel 100 and a panel driver 200.

The light-emitting display panel 100, as shown in FIGS. 1 and 2, includes a plurality of unit pixels P. Each of the unit pixels P includes first to fourth sub-pixels P1, P2, P3 and P4. The first sub-pixel emits light having a first color. The second sub-pixel emits light having a second color. The third sub-pixel emits light having a third color. The fourth sub-pixel emits light having a fourth color.

The panel driver 200 includes a controller 210, a data converter 220, a voltage generator 230, a line memory 240, a source driver 250 and a gate driver 270.

The controller 210 generates a driving control signal on the basis of a preliminary control signal applied by an external graphic controller (not shown). The controller 210 controls the data converter 220, the voltage generator 230, the line memory 240, the source driver 250 and the gate driver 270 on the basis of the driving control signal.

The data converter 220 changes a preliminary data signal 204 provided by the external graphic controller (not shown) into a data signal 221 corresponding to the light emitted by the light-emitting display panel 100 and the data converter 220 outputs the data signal 221. In one exemplary embodiment, when the preliminary data signal 204 includes a data signal of three colors having red, green and blue, the data converter 220 changes the preliminary data signal 204 into a data signal 221 of four colors having red, green, blue and white, and outputs the data signal of four colors having red, green, blue and white to the line memory 240.

The voltage generator 230 generates first to third driving voltages 232, 234 and 236, respectively, to drive the organic light-emitting display apparatus by using a source voltage 206 applied by an exterior source (not shown). The first driving voltage 232 includes a reference gray scale voltage (Vref) 232 to drive the source driver 250. The second driving voltage 234 includes gate voltage 234 Von and gate voltage 234 Voff to drive the gate driver 270. The third driving voltage 236 includes a common voltage Vcom and a bias voltage Vdd to drive the light-emitting display panel 100. In one exemplary embodiment, the common voltage Vcom is applied to the cathode of the first light-emitting element EL1 and the bias voltage Vdd is applied to the driving voltage line VL.

The line memory 240 stores the data signal 221 of four colors having red, green, blue and white provided from the data converter 220 by a horizontal line unit. The line memory 240 sequentially outputs a red data signal, a green data signal, a blue data signal and a white data signal from the stored data signal 221 of the horizontal line on the basis of the driving control signal from the controller 210.

The source driver 250 changes the data signal provided from the line memory 240 into an analog typed data signal and outputs the analog typed data signal to the data lines DL1, . . . , DLm.

In one exemplary embodiment, the source driver 250 sequentially outputs data signals provided from the line memory 240 to the data lines DL1, . . . , DLm during one horizontal (“1H”) period. The source driver 250 outputs the red data signal to the data lines DL1, . . . , DLm during a first period of the 1H period. The source driver 250 outputs the green data signal to the data lines DL1, . . . , DLm during a second period of the 1H period. The source driver 250 outputs the blue data signal to the data lines DL1, . . . , DLm during a third period of the 1H period. The source driver 250 outputs the white data signal to the data lines DL1, . . . , DLm during a fourth period of the 1H period.

The gate driver 270 generates gate signals G1, . . . , Gn according to the driving control signal of the controller 210 and outputs the gate signals G1, . . . , Gn to gate lines GL1, . . . , GLn of the light-emitting display panel 100.

In one exemplary embodiment, the gate driver 270 sequentially outputs first to fourth gate signals G1, G2, G3 and G4 on the basis of the driving control signal during the 1H period. The gate driver 270 outputs the first gate signal G1 to the first gate line GL1 during the first period of the 1H period. The gate driver 270 outputs the second gate signal G2 to the second gate line GL2 during the second period of the 1H period. The gate driver 270 outputs the third gate signal G3 to the third gate line GL3 during the third period of the 1H period. The gate driver 270 outputs the fourth gate signal G4 to the fourth gate line GL4 during the fourth period of the 1H period.

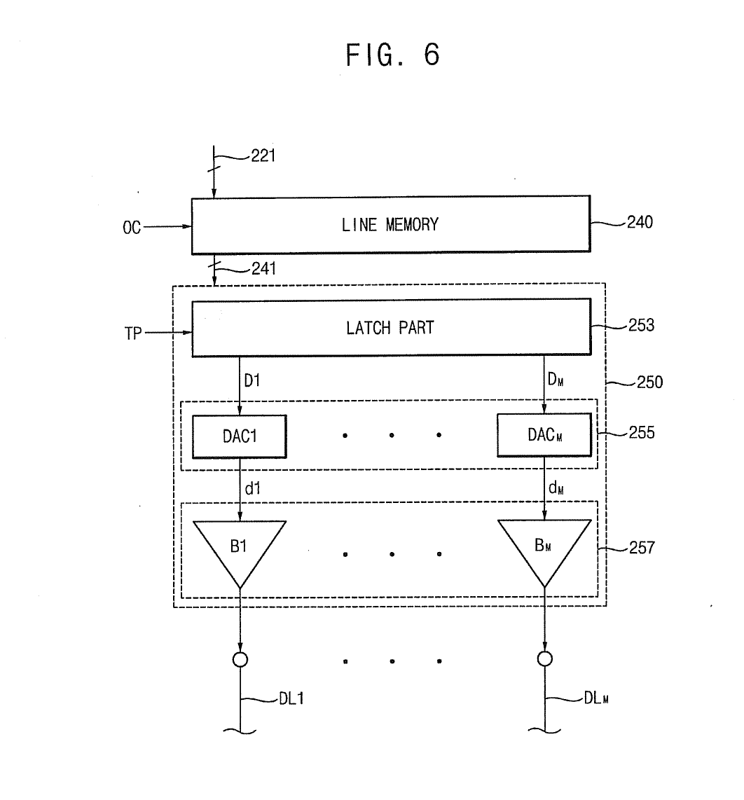

FIG. 6 is a block diagram illustrating a source driving part shown in FIG. 5.

Referring to FIGS. 5 and 6, an exemplary embodiment of the source driver 250 includes a latch part 253, a digital-analog converting part 255 and an output buffer part 257.

Data signals of one horizontal line are stored in the line memory 240. The red, green, blue and white data signals of the data signals stored in the line memory 240 are sequentially read out and outputted to the source driver 250.

The latch part 253 sequentially latches the red, green, blue and white data signals in correspondence with the data signals read out from the line memory 240 and sequentially loads the red, green, blue and white data signals in response to the driving control signal applied by the controller 210.

In one exemplary embodiment, the latch part 253 latches the red data signal during the first period of the 1 H period and outputs the red data signal D1, . . . , Dm in response to a load signal TP applied by the controller 210, wherein “m” is a natural number.

The red data signal D1, . . . , Dm outputted by the latch part 253 is inputted to the digital-analog converting part 255.

The digital-analog converting part 255 includes m-number of digital-analog converters DAC1, . . . , DACm. The digital-analog converting part 255 converts the red data signal D1, . . . , Dm into an analog typed red data voltage d1, . . . , dm and outputs the red data voltage d1, . . . , dm to the output buffer part 257.

The output buffer part 257 includes m-number of output buffers B1, . . . , Bm. The output buffer part 257 stores the red data voltage d1, . . . , dm outputted by the digital-analog converting part 255, and outputs the stored red data voltage d1, . . . , dm to the source lines DL1, . . . , DLm.

The source driver 253 converts the green data signal into an analog typed green data voltage and outputs the analog typed green data voltage to the data lines DL1, . . . , DLm during the second period of the 1H period. The source driver 253 converts the blue data signal into an analog typed blue data voltage and outputs the analog typed blue data voltage to the data lines DL1, . . . , DLm during the third period of the 1H period. The source driver 253 converts the white data signal into an analog typed white data voltage and outputs the analog typed white data voltage to the data lines DL1, . . . , DLm during the fourth period of the 1H period.

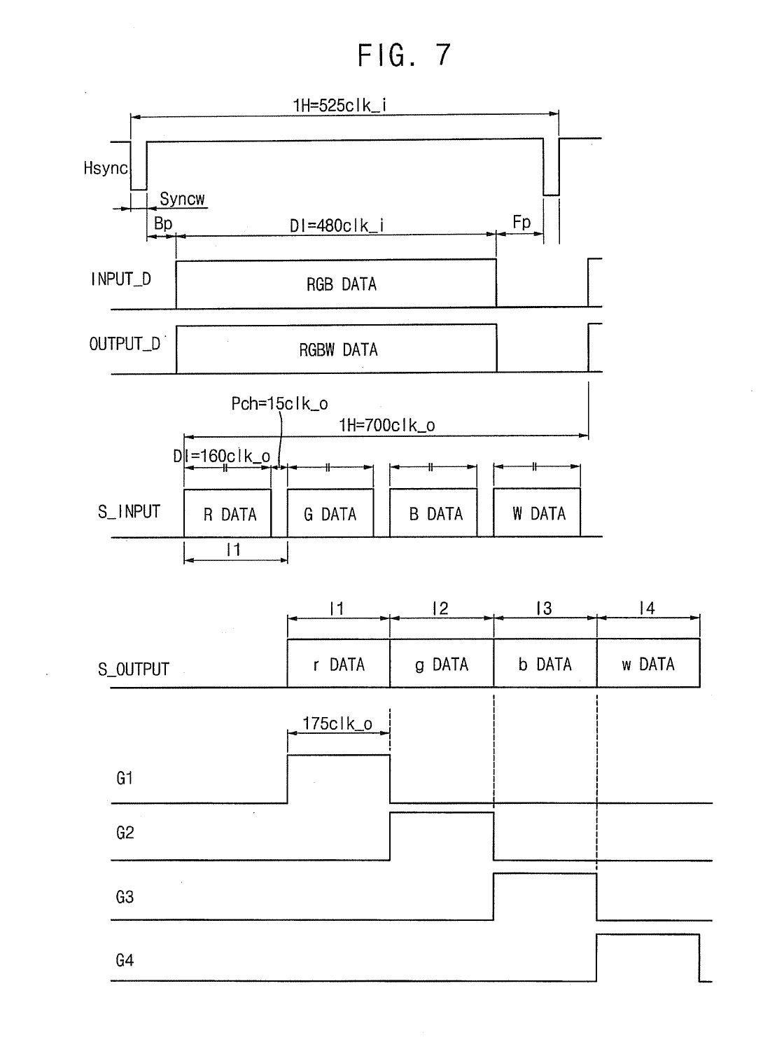

FIG. 7 is a timing diagram illustrating an exemplary method of driving the display apparatus shown in FIG. 5.

Referring to FIGS. 5 and 7, an exemplary method of driving the display apparatus includes the controller 210 generating a driving control signal to drive the organic light-emitting display apparatus on the basis of the preliminary control signal 202.

In one exemplary embodiment, the controller 210, as shown in Table 1, generates an output clock signal clk_o, which is the driving control signal, by using an input clock signal clk_i, which is the preliminary control signal 202. The controller 210 controls each of the data converter 220, the line memory 240, the source driver 250 and the gate driver 270 on the basis of the driving control signal.

TABLE 1
Condition of device: FRAME Freq. 60 Hz/16.7 milliseconds (ms),
WqVGA (480 pixels × 286 pixels)

| | |
|---|---|
| PRELIMINARY | DRIVING |
| CONTROL SIGNAL | CONTROL SIGNAL |
| INPUT CLOCK (clk_i) Freq. | OUTPUT CLOCK (clk_o) Freq. |
| 9.0 MHz/111 nanoseconds (ns) | 12.0 MHz/83.3 nanoseconds (ns) |

| | | | |
|---|---|---|---|
| H total | 525 clk_i | H total | 700 clk_o |
| H DI | 480 clk_i | H DI | 160 clk_o |
| H syncw | 41 clk_i | H Pch | 15 clk_o |
| H Bp | 2 clk_i | | |
| H Fp | 2 clk_i | | |
| V total | 286 H | V total | 286 H |
| V DI | 272 H | V DI | 272 H |
| V syncw | 10 H | V syncw | 10 H |
| V Bp | 2 H | V Bp | 2 H |
| V Fp | 2 H | V Fp | 2 H |

The data converter 220 converts a red, green and blue data signal RGB DATA, which is the preliminary data signal INPUT_D input on the basis of the input clock signal clk_i, into a red, green, blue and white data signal RGBW DATA and outputs the red, green, blue and white data signal OUTPUT_D.

The controller 210 stores the red, green, blue and white data signal RGBW DATA outputted by the data converter 220 in the line memory 240 by the 1H period. The controller 210 sequentially reads out the red data signal, the green data signal, the blue data signal and the white data signal from the data signal stored in the line memory 240 and outputs the red data signal, the green data signal, the blue data signal and the white data signal to the source driver 250. The controller 210 sequentially reads out the red data signal, the green data signal, the blue data signal and the white data signal on the basis of the output clock signal clk_o and inputs the red data signal, the green data signal, the blue data signal and the white data signal to the source driver 250 S_INPUT.

In one exemplary embodiment, the controller 210 reads out the red data signal R DATA from the line memory 240 and inputs the red data signal R DATA to the source driver 250 during the first period I1 of the 1H period. The controller 210 reads out the green data signal G DATA from the line memory 240 and inputs the green data signal G DATA to the source driver 250 during the second period I2 of the 1H period. The controller 210 reads out the blue data signal B DATA from the line memory 240 and inputs the blue data signal B DATA to the source driver 250 during the third period I3 of the 1H period. The controller 210 reads out the white data signal W DATA from the line memory 240 and inputs white data signal W DATA to the source driver 250 during the fourth period I4 of the 1H period. Each of the first to fourth periods I1, I2, I3 and I4 includes a data section DI and a blanking section Pch. The data signal is substantially processed during the data section DI. The data signal is not processed during the blanking section Pch. Namely, the data section DI, as shown in Table 1, corresponds to 160 clk_o and 160 times per 83.3 nanoseconds (ns) and the blanking section Pch corresponds to 15 clk_o and 15 times per 83.3 nanoseconds (ns).

The source driver 250 converts the red, green, blue and white data signals of a digital type, which are inputted during the one horizontal section 1H period, into the red, green, blue and white data voltages of an analog type and outputs the red, green, blue and white data voltages to the data lines DL1, . . . , DLm.

In one exemplary embodiment, the source driver 250 outputs the red data voltage r DATA to the data lines DL1, . . . , DLm during the first period I1 of the 1H (700 clk_o) period. The source driver 250 outputs the green data voltage g DATA to the data lines DL1, . . . , DLm during the second period I2 of the 1H period. The source driver 250 outputs the blue data voltage b DATA to the data lines DL1, . . . , DLm during the third period I3 of the 1H period. The source driver 250 outputs the white data voltage w DATA to the data lines DL1, . . . , DLm during the fourth period I4 of the 1H period.

The gate driver 270 sequentially outputs the first to fourth gate signals G1, G2, G3 and G4 to the first to fourth gate lines GL1, GL2, GL3 and GL4 on the basis of the driving control signal during the 1H period, respectively. A high level section of each of the gate signals is about 14.5 microseconds (μs) (175 times per 83.3 nanoseconds (ns)), which is one-fourth of the 1H period (“1H/4”). This is a sufficient time in the light-emitting display panel of an apparatus having a small or medium size display panel to complete one cycle of outputting gate signals G1, G2, G3 and G4.

Unit pixels arranged on the horizontal line are driven in the above mentioned method during the 1H period to display an image. A plurality of unit pixels arranged in a matrix shape on the light-emitting display panel 100 is driven during 1 frame to display a frame image.

As described above, the light-emitting display panel having the light-emitting element includes a plurality of unit pixels, each of which includes sub-pixels arranged in a horizontal direction. Each sub-pixel uses the same data line and the same bias driving voltage line to drive a light-emitting element. Therefore, the number of each of the data lines and bias driving voltage lines may be decreased and consequently, the aperture ratio may be improved. Also, the number of source driving chips may be decreased as a number of the data lines are decreased. Therefore, the manufacturing costs thereof may be reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A display panel comprising:
a plurality of data lines each extended in a first direction substantially parallel with each other;
a plurality of driving voltage lines each extended substantially parallel with the plurality of data lines;
a plurality of gate lines each extended in a second direction substantially perpendicular to the-first direction; and
a plurality of unit pixels each including a plurality of sub-pixels, each sub-pixel of a corresponding unit pixel including a switching element electrically connected to a same data line of two adjacent data lines and one of two adjacent gate lines, and a driving element electrically connected to the switching element and a same driving voltage line, the driving element driving a light-emitting element.

2. The display panel of claim 1, wherein the sub-pixel of the corresponding unit pixel further comprises a storage capacitor which includes a first electrode electrically connected to the switching element and the driving element, and a second electrode electrically connected to the same driving voltage line.

3. The display panel of claim 1, wherein the plurality of sub-pixels of the corresponding unit pixel comprises:
a first sub-pixel including a first switching element electrically connected to an i-th data line and a (4j-3)-th gate line and a first driving element electrically connected to the first switching element and an i-th driving voltage line, the first driving element drives a first light-emitting element;
a second sub-pixel including a second switching element electrically connected to the i-th data line and a (4j-2)-th gate line and a second driving element electrically connected to the second switching element and the i-th driving voltage line, the second driving element drives a second light-emitting element;
a third sub-pixel including a third switching element electrically connected to the i-th data line and a (4j-1)-th gate line and a third driving element electrically connected to the third switching element and the i-th driving voltage line, the third driving element drives a third light-emitting element; and
a fourth sub-pixel including a fourth switching element electrically connected to the i-th data line and a 4j-th gate line and a fourth driving element electrically connected to the fourth switching element and the i-th driving voltage line, the fourth driving element drives a fourth light-emitting element, wherein each of “i” and “j” is a natural number.

4. The display panel of claim 3, wherein each of the first to fourth light-emitting elements comprises a light-emitting layer and the light-emitting layers of the first to fourth light-emitting elements respectively emit light having a different color from each other.

5. The display panel of claim 3, wherein each of the first to third light-emitting elements comprises a color filter and a color of each of the color filters is different from each other.

6. The display panel of claim 3, wherein the first to fourth light-emitting elements respectively emit red light, green light, blue light and white light.

7. A display apparatus comprising:
a display panel comprising a plurality of unit pixels, each unit pixel comprising:
a first sub-pixel including a first light-emitting element electrically connected to a data line and a first gate line, the first light-emitting element emits light having a first color;
a second sub-pixel including a second light-emitting element electrically connected to the data line and a second gate line, the second light-emitting element emits light having a second color;
a third sub-pixel including a third light-emitting element electrically connected to the data line and a third gate line, the third light-emitting element emits light having a third color; and
a fourth sub-pixel including a fourth light-emitting element electrically connected to the data line and a fourth gate line, the fourth light-emitting element emits light having a fourth color;
a source driver which sequentially outputs a first data signal of the first color, a second data signal of the second color, a third data signal of the third color and a fourth data signal of the fourth color to the data line during a one horizontal (1H) period; and
a gate driver which sequentially outputs first to fourth gate signals to the first to fourth gate lines.

8. The display apparatus of claim 7, further comprising:
a controller which generates a driving control signal which controls the source driver and the gate driver on a basis of a preliminary control signal inputted by an exterior controller; and
a data converter which converts the preliminary control signal inputted by the exterior controller into data signals of first to fourth colors.

9. The display apparatus of claim 8, wherein the source driver outputs the data signal of the first color to the data line during a first period of the one horizontal (1H) period, the data signal of the second color to the data line during a second period of the one horizontal (1H) period, the data signal of the third color to the data line during a third period of the one horizontal (1H) period and the data signal of the fourth color to the data line during a fourth period of the one horizontal (1H) period.

10. The display apparatus of claim 9, wherein a length of each the first to fourth periods is substantially the same as each other.

11. The display apparatus of claim 9, wherein the gate driver outputs the first gate signal to the first gate line during the first period, the second gate signal to the second gate line during the second period, the third gate signal to the third gate line during the third period and the fourth gate signal to the fourth gate line during the fourth period on the basis of the driving control signal.

12. The display apparatus of claim 11, wherein a high level section of each of the first to fourth gate signals is about one-fourth of the one horizontal (1H) period (1H/4).

13. The display apparatus of claim 7, wherein the display panel further comprises a driving voltage line which extends substantially parallel with the data line, the driving voltage line being adjacent to the data line.

14. The display apparatus of claim 13, wherein the first sub-pixel comprises a first switching element electrically connected to the data line and the first gate line and a first driving element electrically connected to the driving voltage line, the first driving element drives a first light-emitting element,
the second sub-pixel comprises a second switching element electrically connected to the data line and the second gate line and a second driving element electrically connected to the second switching element and the driving voltage line, the second driving element drives a second light-emitting element,
the third sub-pixel comprises a third switching element electrically connected to the data line and the third gate line and a third driving element electrically connected to the third switching element and the driving voltage line, the third driving element drives a third light-emitting element, and
the fourth sub-pixel comprises a fourth switching element electrically connected to the data line and the fourth gate line and a fourth driving element electrically connected to the fourth switching element and the driving voltage line, the fourth driving element drives a fourth light-emitting element.

15. An organic light-emitting display apparatus comprising:
a data line which extends in a first direction;
a driving voltage line which extends substantially parallel with the data line;
a gate line which includes first to third gate lines, each of the first to third gate lines extends in a second direction substantially perpendicular to the first direction; and
a pixel part which includes a first sub-pixel electrically connected to the data line and the first gate line, a second sub-pixel electrically connected to the data line and the second gate line and a third sub-pixel electrically connected to the data line and the third gate line.

16. The organic light-emitting display apparatus of claim 15, further comprising a fourth gate line which extends in the second direction, wherein the pixel part further comprises a fourth sub-pixel electrically connected to the data line and a fourth gate line.

17. The organic light-emitting display apparatus of claim 15, further comprising a color filter formed in at least one of the first to third sub-pixels.

18. The organic light-emitting display apparatus of claim 15, wherein the pixel part comprises an organic electroluminescent layer which emits light having a white color.

19. A method of driving a display apparatus, the method comprising:
receiving a driving control signal to drive a display apparatus, the display apparatus includes a data line, a driving voltage line, a gate line which includes first to third gate lines and a unit pixel part which includes a first sub-pixel electrically connected to the data line and the first gate line, a second sub-pixel electrically connected to the data line and the second gate line and a third sub-pixel electrically connected to the data line and the third gate line, each sub-pixel includes a switching element and a driving element, the switching element and the driving element electrically connected to the data line and the driving voltage line;
converting the driving control signal from a digital typed signal to an analog typed signal; and
outputting the analog typed signal to the data line electrically connected to the first to third sub-pixels, in which the driving elements are supplied with a voltage from the driving voltage line.
